(19) United States
(12) Patent Application Publication
(10) Pub. No.: US 2024/0086856 A1
(43) Pub. Date: Mar. 14, 2024

(54) SYSTEM FOR TRIGGERING COMMUNICATIONS

(71) Applicant: Wells Fargo Bank, N.A., San Francisco, CA (US)

(72) Inventors: John C. Brenner, Chesterfield, MO (US); Donna Marie Greene, Oakboro, NC (US); Carter C. Hansen, Huntersville, NC (US); Tambra Nichols, Charlotte, NC (US); Elizabeth Long Swindler, Gastonia, NC (US); Keith Meade Sykes, Charlotte, NC (US)

(21) Appl. No.: 15/978,622

(22) Filed: May 14, 2018

(51) Int. Cl. G06Q 10/10; G06F 3/01; G10L 17/26; G10L 25/63

(52) U.S. Cl. CPC G06Q 10/1093; G06F 3/011; G10L 17/26; G10L 25/63; G06F 2203/011

(57) ABSTRACT

A computer-implemented system and method are provided for adaptively controlling communication activity of a communication system. The method stores user information comprising contact preferences, a goal, and account information. The system may receive external information by a trigger engine which applies a trigger rule to determine a degree of relatedness between the goal and at least one of external information and the account information. When the degree of relatedness exceeds a threshold, then the contact preferences may be used to format a communication related to the external information based on the contact preferences. The system may then send the communication to the user by the communication entity according to the contact preferences, and, based on a feedback or lack of feedback from the user related to the communication, adjust at least one of the contact preferences, the trigger rule, or a weighting factor of the trigger rule.

### TECHNICAL FIELD

Described herein is a computer-based system that utilizes engagement triggers to determine whether to engage the user in communications based on various situations and events that may occur as they relate to a user's goals. The system may adjust the triggers based on user feedback or other factors. The system may provide scheduling for communications with users and create different groups of users for different levels of communications.

### BACKGROUND

Communications between a user and a service provider are important for maintaining an ongoing relationship. However, it may be difficult to know the best channels/forms, times, and frequency of these communications. If the communications are too infrequent, use a channel or form that is not easy for the user to use, or are available at inconvenient times, there may be wasted resources in communications that are not fully utilized. However, if the communications are too frequent or include too much information, there may be wasted resources in that the communications are not read. Thus, determining the right parameters for communications with the user are important. Also, it may be important to communicate information in a positive manner, even though the communication content may be about a negative event or situation.

### SUMMARY

Disclosed herein is a computer-implemented method for adaptively controlling communication activity of a communication system, the method comprising using a processor for storing user information for a user, the user information comprising contact preferences, a goal comprising information related to a future objective of the user, and account information. The system may receive external information from an external data source by a trigger engine which applies a trigger rule to determine a degree of relatedness between the goal and at least one of external information and the account information, based on a trigger rule criterion.

When the degree of relatedness exceeds a threshold value, then the contact preferences may be used to format a communication related to the external information for a communication entity based on the contact preferences. The system may then send the communication to the user by the communication entity according to the contact preferences, and, based on a feedback or lack of feedback from the user related to the communication, adjust at least one of the contact preferences, the trigger rule, or a weighting factor of the trigger rule.

Disclosed herein is also a customer experience generation system comprising a hardware processor, a non-volatile memory-based storage device connected to the hardware processor comprising instructions that, when executed on the processor, configure the processor to perform the following.

The processor may be used to store user information for a user in the storage device, the user information comprising contact preferences, a goal comprising information related to a future objective of the user, and account information. External information may be received from an external data source by a trigger engine, and the system may use a trigger engine to apply a trigger rule to determine a degree of relatedness between the goal and at least one of external information and the account information, based on a trigger rule criterion. When the degree of relatedness exceeds a threshold value, then the contact preferences may be used to format a communication related to the external information for a communication entity based on the contact preferences. The processor may then be used to send the communication to the user by the communication entity according to the contact preferences, and, based on a feedback or lack of feedback from the user related to the communication, adjust at least one of the contact preferences, the trigger rule, or a weighting factor of the trigger rule.

Described herein is also a non-transitory computer-readable storage medium, the computer-readable storage medium including instructions that when executed by a processor, cause the processor to perform the operations described above.

### BRIEF DESCRIPTION OF THE DRAWINGS

In the drawings, which are not necessarily drawn to scale, like numerals may describe similar components in different views. Like numerals having different letter or numeric suffixes may represent different instances of similar components. The drawings illustrate generally, by way of example, but not by way of limitation, various embodiments discussed in the present document.

FIG. 1 is a block diagram providing an overview of an example engagement trigger system, according to an implementation.

FIG. 2 is a flowchart illustrating an example process of the system engaging with a user when a trigger condition is met, according to an implementation.

FIG. 3 is a block diagram illustrating an example of a machine that may be a computer on which various processes described herein may be performed.

FIG. 4 is a block diagram of an example of a distributed computing system within which various processes described herein may be performed.

### DETAILED DESCRIPTION

Good communications between a business entity and a user is essential for maintaining a good relationship, and generally the more communication the better, provided the communication is desired by the user. The proper amount of these communications as well as the channels by which the communications are made may, at times be difficult to determine and depend on a number of factors. Furthermore, user communications consume time, effort, and physical resources of the business entity and therefore the business must invest these resources in a manner most likely to maximize the benefit everyone receives from the communications.

A use case is described below in which the business entity is a financial institution and the user is an investment customer. Depending on various factors, a advisor (FA) may be assigned to assist the customer, or the customer, depending on the circumstances, may be assisted by a robot or automated advisor. However, this use case is only provided for ease of explanation, and it should be realized that the concepts described herein can generalize to a situation in which any two entities have an ongoing relationship that may benefit from periodic communications.

Using traditional communication channels for users of services that rely solely on automated messages or common communication channels of an advisor may run a risk of either missing potential communication opportunities that may be beneficial to a user or of being overly intrusive and bothersome. If the communications between the service provider and the user are too infrequent, communication opportunities might be missed that could benefit both parties. Additionally, the user may feel underserved if the communications are not at a desired level. If the communications originating from the user are too frequent, unnecessary technical resources may be used up in the communications. If the communications originating from the service provider are too frequent, the user might feel pestered or harassed and begin ignoring communication attempts by the service provider, or, in a worst-case scenario, sever their relationship.

Thus, establishing a desirable amount of communication between the service provider and the user using better channels of communication may benefit the long-term relationship and make more efficient use of technical resources. Described below are various system and method elements that may help to individualize the frequency of communications between a service provider and a user or group of users, and strike a proper balance between not communicating enough and communicating too much while being mindful of technical resources available for the communication. By utilizing intelligent engagement triggers that are based on various goals, feedback, and modularization of communications components, improved communications may be realized. These improved communications may improve the utilization of technical resources and in addition help users better achieve their goals, increase loyalty to the service provider, increase customer assets, and make users aware of products or services that may be of value to them. The form and desirable amount of communication may result in part from direct responses by users to inquiries, and may be adjusted based on received feedback. The feedback may be direct expression of the user or inferred from activities of the user.

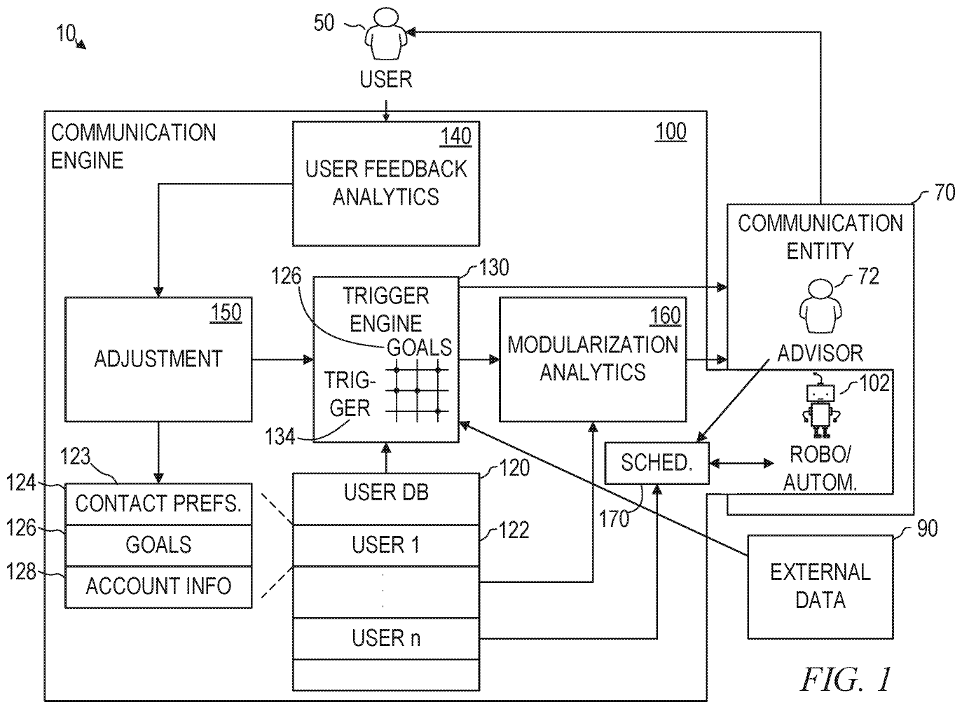

FIG. 1 is a block diagram of a system 10 illustrating various elements used to improve communications between a user 50 and a communication entity 70 of the business entity. The communication entity 70 may be an actual person, such as a advisor 72, or it may be a robotic entity or other form of automated communications 102, the latter being a part of a communication engine 100 described in more detail below.

### User Information

Information about the user 50 may be stored in the user database 120, which may comprise records 122 about individual users. Each record 122 may comprise user information 123 that may comprise contact preferences 124, goals 126, and account information 128. The contact preferences 124 may be at least partially obtained via a questionnaire, described in more detail below, and may include information about the user's 50 preferences for communications channels, times, content, contact frequency, and volume, which may be set based on defaults associated with the user characteristics such as age, gender, and other demographic defaults, derived from the initially collected information from the user about their preferences, and adjusted over time based on received feedback. The communication channels may include a phone call, email, text/messaging, text-based chat, virtual reality communication, the use of wearable communication devices, or physical letters via mail. These channels may be utilized by the advisor 72, the automated communications 102, or some combination of both.

An initial step in working with a user 50 may be to obtain user information 123 and to understand their goals 126. This may be achieved by, at least partially, for example, providing them with an initial user questionnaire. The questionnaire may be in the form of: a) a physical questionnaire that the user 50 may fill out with a pen, b) a computer-based questionnaire, such as an on-line questionnaire accessible via a web browser, or c) a questionnaire administered by the advisor 72, which permits gal information to be obtained in more of a dialog format. More detailed gal-related information may be obtained by having the user 50 attend a “boot camp” in which an in-depth process for determining the user's 50 gals 126 may be determined.

The determination of gals 126 may involve collecting information about the user's 50 life scenario, including e.g., past and present events, the user's 50 actual stated goals, such as thing the user is worried about (risks), age, family, current income, holding, and other baseline information. This could be prefilled. The user's 50 goals 126 may also be implied or predicted goals 126. An example of an implied or predicted goal might be the provision of supplementary health insurance after the age of sixty-five, or college tuition if the user 50 indicates a goal of having children.

The account information 128 may include information about a user's 50 past and current financial holding, and may include checking and saving accounts, stocks, bonds, mutual funds, and other types of financial instruments.

The communication engine 100 may utilize a trigger engine 130 as a main component for determining triggers for communications between the communication entity 70 and the user 50. The trigger engine 130 may receive input from, for example, external data 90 and a user database 120 containing information about users of the business. The trigger engine 130 may associate a user's 50 goals 126 and a trigger 134 that may be associated with those goals 126.

### Triggers

Communications between the communication entity 70 and the user 50 may be initiated based on various triggers 134 in the trigger engine 130, the triggers 134 being related to the goals 126. The triggers 134 may be broken down into various categories. Event-based triggers may include: a) time-based events, such as a user's birthday or other age-related event, b) financial events, such as a periodic receipt of an income check, payment of a mortgage, taxes, etc., c) a family event, such as a birth, getting married, a job change, moving retirement, family death, d) a health event, such as a pregnancy or an illness, and e) an external event, such as a news event about a particular business or business sector, a news event impacting the stock/bond market as a whole, a regional catastrophe, etc. Periodic time-based triggers 134 may be utilized to check in with the user 50 and provide them with relevant information about the status of their portfolio or news that may be of interest to them.

In one implementation, the communications are deliberately made in an exclusively positive form, such as using a positive tone or words having a positive connotation versus use of a negative tone and/or words being used that are critical of past actions taken. This is done so that the user 50 is left with a good feeling after the communication. For example, a trigger 134 for a monthly communication about the portfolio status could incorporate a congratulatory message that the portfolio continues to track the user's 50 goals 126 and that the user's retirement is still on schedule. Thus, the triggers 134 may emphasis communications that serve to reinforce positive activities by indicating that they are doing well. The determination of positive and negative tone words may be performed by a database that contains lists of words and an indication as to whether they are considered generally positive or generally negative words.

In situations where potentially negative news may be present, the communications to the user 50 may still be presented in as positive of a manner as possible to encourage the user 50 to take beneficial actions. For example, a 500-point stock market loss may trigger 134 a message to the user 50 that such losses are traditionally temporary, that the user's 401(k) plan is still purchasing stocks that are now cheaper, and that this brief setback should not impact the user's 50 goal 126 of retiring in ten years. Using the triggers 134 to encourage positive communications to take place with the user 50 permits effective positive reinforcement to solidify the user relationship and encourage positive or desired behaviors of the user at the best time and in the best way for that user.

The triggers 134 may also include predictive trigger rules, which may be indicators of change. These may include detected income/source change, a meaningful change to cash flow, portfolio drifting (e.g., a change in portfolio value or content with respect to goals—such a change may cause a rebalance recommendation calculation to take place), spending/dollars out (e.g., unanticipated medical or other expenses), and out-of-pattern cash flow (in or out). The predictive trigger rules may also be based on a detected user attribute, such as a detected emotional style. For example, a person who tends to be emotionally high strung may require more frequent communications and reassurance than someone with a calmer disposition.

Finally, the triggers 134 may be user behavior triggers, which may involve past user actions. These past user actions may include how the user has reacted to events or past recommendations, e.g., a prior user reaction to an event. The past user actions may relate to a user indication of desired activities, which are desired activities the user has indicated they may be wanting to get involved with. These desired activities may include involvement with particular types of stocks, greater safety in bonds, etc.

The trigger engine 130 may include an inventory of possible triggers which may include multi-user triggers 134 or a multi-user trigger rule applicable globally to all users in the database, multi-user triggers 134 applicable to groups or individuals having certain attributes, and triggers 134 specific to users 50, 122. The various attributes may be combinable by utilizing weightings and various attributes or threshold criteria. By way of example, a first attribute may be an amount of change in the dollar amount in a user's saving account. The first attribute may have a weighting factor applied to it. In an illustrative example, the weighting factor W₁ may be 0.8, and the amount of change is $100K, yielding a value of 80K. The second attribute may be a number of investment changes in the past year made by the user. In the illustrative example, for this attribute, the weighting factor W₂ may be 10,000. The user executed five investment changes in the past year. A trigger value may be set according to a rule that requires the first attribute with its weighting factor combined with the second attribute with its weighting factor must be greater than 100K in order to trigger the communication. Or, in mathematical form:

W₁A₁+W₂A₂>100,000.

In this case, 0.8*100,000+10,000*5=130,000, which is greater than the threshold of 100K, and thus, the combined factors with their respective weightings are sufficient to overcome the threshold requirement for the combined factors and weightings to trigger the communication.

By way of another example, if a news story about an ecological disaster caused by Company A comes out, a newsfeed of this event is provided originating as external data 90 to the trigger engine 130. Two users 50, 122 hold mutual funds that include Company A stocks. User 1 has indicated in her goals that she strongly favors green companies and would like to be made aware of ecologically significant news with respect to her portfolio. Past historical activity in User 1's portfolio indicates that she is willing to aggressively move funds around in order to maintain a green portfolio. User 2 has also indicated in his goals that he favors green companies, but indicated that this is a low-level priority versus return on investment. Also, User 2 shows a very low propensity to move his funds around. In this situation, the ecological news trigger 134 may be weighted more heavily for User 1 than User 2, despite the fact that they both have indicated a goal of having a green portfolio. With this heavier weighting, the ecological news trigger 134 may activate the communication entity 70 to contact User 1, whereas this trigger 134 may not reach a threshold value to contact User 2. Any mathematical formulaic expression may be utilized to determine whether the triggers 134 invoke the communication entity 70 to contact one or more of the users 50.

The goals 126 and the triggers 134 may be continuously adaptable and may utilize user feedback analytics 140 to determine trigger weightings and even the triggers 134 themselves. For example, the communication engine 100 may activate particular triggers 134 and initiate communications via the communication entity 70 to users or groups based on events from the external data sources 90 or from changes in user information in the user database 120.

The user feedback analytics 140 may determine various response feedback communications received from the users 50, such as emails, telephone calls to the advisor 72 or interactions with the automated communications 102. In one implementation, the communication engine may try certain triggers 134, utilize the user feedback analytics 140 to determine the user 50 response, and then use the analyzed feedback to adjust, via an adjustment element 150, various trigger weighting or eliminate certain triggers 134 altogether.

The adjustment element 150 may, for example, gradually reduce trigger weightings when the user 50 is slow to respond or fails to respond to a communications for which a response is anticipated, or it may terminate a trigger in response to, e.g., an express request from the user 50 not to receive particular types of communications. The adjustment element could adjust the user preferences themselves as well.

The user feedback analytics 140 may operate at a user 50 level or at a user group level so that if enough users having some sort of attribute appear to be responding to a particular communication in a particular way, this information may be used to influence communications with other like-situated users. For example, if users collectively respond negatively to politically charged news, then triggers 134 that may be associated with communicating such news may have their weightings reduced or the triggers may be removed altogether, and thus impact other users 50 who may not have been recipients of such communications already. In other words, or more generally, feedback information about the communications with one user 50 or groups of users may be used to determine the form and content of communications with different users. User feedback may be solicited directly in the communications sent to them, for example, in the forms of a thumbs-up or thumbs-down displayed on a device of the user, or by some other user-selectable indication as to whether the communication was wanted or not, or whether future communications similar to this are desired. The feedback may be received by the system over the network in the form of an email, a message, or via an app or client running on a device of the user. Or this feedback may be implicitly determined based on, e.g., speed/frequency or content and channel of response. The multi-user trigger rule may be based on feedback received from a plurality of users.

The advisor 72 may be able to provide certain types of feedback that allows the triggers 134 or their weights to be adjusted as well as the type or content of the triggered communications (or the automatic communications 102 could do the same with an artificial intelligence (AI) component). For example, if a good article on Bitcoin fraud came out and a number of a advisor's 72 users 50 were asking for it and giving it good reviews, this article could be communicated to a wider audience by the advisor 72 (or automatic communications 102) adjusting the triggers 134 or their weights to make it more likely that the Bitcoin fraud article would be communicated to other users 50 of the business entity.

The trigger engine 130, based on the user goals 126, may include relevant triggers 134 and factors that the communication engine 100 may monitor, considering whether particular trigger 134 supports or negates a goal 126, e.g., provides a relationship as to whether the trigger helps or hurts the goal. The trigger engine 130 may interact with the user database 120 to establish ongoing monitoring of a particular trigger 134, which could include looking at the account information 128 in conjunction with the goals 126 and then determining when there is a mismatch between the goals 126 and the account information. The trigger engine may apply a trigger rules to determine a degree of relatedness between the goal and at least one of the external information or the account information based on a trigger rule criterion, such as those discussed above. The degree of relatedness may consider, for example, a number of common or related words between those of the user's goals 126 and those contained in the external information. For example, an external communication in the form of a news story may contain the name of a particular company known for its environmentally friendly policies. If the user's goals 126 include goals related to green ecological companies, then it might be determined that the news story has a high degree of relatedness with the user's goals 126.

The contact preferences 124 may include information as to the communication channel (call, email, chat, etc.) and communication entity 70 (advisor 72 or automated communications 102) to utilize, and the triggers 134 may incorporate the channel or entity based on the event or information received. For example, one trigger 134 might indicate that for a detected 500-point stock market crash via the external data 90, the trigger engine 130 notifies the advisor 72 to place a telephone call to User 1. Another trigger 134 might indicate that for a detected change, via the external data 90, in the Board of Directors of a company in which User 1 holds stock, the trigger engine 130 notifies the automatic communications 102 to send an email with a link to a detailed article to User 1.

In a further example, the trigger engine 130 detects that User 1's portfolio is down 10% over where User 1's goals had it, and a trigger 134 notifies the automatic communications 102 to send a text to User 1 with an invitation to speak with the advisor 72. Here, the trigger engine 130 may also notify the advisor 72 of this invitation and to follow up with User 1 if nothing is heard within a particular period of time. In another implementation, the automatic communications 102 could communicate with the advisor 72 regarding the invitation and follow-up call.

Also, the correct communication entity 70 as well as the communication channel may be determined dynamically and situation-dependent. For example, although a particular trigger 134 may indicate that the advisor 72 should call the user 50, the advisor may be unavailable, e.g., on vacation. In that situation, a backup action may be performed such as sending the user an email by the automatic communications 102. Or, if the user 50 is on vacation, a more suitable communications channel, such as a chat, may be selected over a preferred channel that may be used of the user 50 were at home.

In addition to the communication entity 70 and channels of communication, the trigger engine 130 may also factor in a time component. For example, certain triggers may warrant immediate communications, such as something that has an impact on the user's 50 portfolio and requires immediate action on their part. This information could be pushed out to the user via a text message or email designated as urgent and soliciting return communications from the user 50. Other triggers may warrant much less urgency, such as a published five-year plan for a company that the user 50 owns stock in. In this less urgent situation, the trigger may wait for a particular preferred time for such communications. The preferred time may be based on contact preferences 124 indicated by the user 50, or it could be based on user 50 activities. For example, if the user feedback analytics 140 determines that the user 50 has a thirty-minute commute to work every day via the train, the trigger engine 130 may utilize that information to send email messages, using the automatic communications 102, to the user 50 at the particular time the user 50 is determined to start his travels.

The triggers 134 may relate to different purposes for initiating communications, including a) discussing new opportunities; b) providing education; c) promoting the community; d) presenting options to mitigate a negative outcome; e) reinforcing positive actions/steps; f) providing product recommendations; and g) providing information on financial implications of various behaviors (e.g., a sliding retirement data calculator).

As noted initially, user communications consume time and effort resources of the business entity and therefore the business must invest these resources in a manner most likely to maximize the benefit everyone receives from the communications, and the advisor 72 often triages resources when communicating with users. A user 50 with a small portfolio might not merit an extensive communication resource interaction, such as a two-hour telephone discussion with a advisor 72, when the stock market drops three hundred points, particularly if that user 50 has not expressed an interest in frequent communications historically. In contrast, a user 50 with a very large portfolio that is very sensitive to stock market swings and who has historically been involved in frequent communications might merit such a two-hour telephone discussion with their advisor 72 given such a market drop.

As a practical matter, less resource-demanding communications, such as pre-recorded monolog text messages, and emails, may be favored over more resource-demanding communications, such as a personal telephone call, a presentation, meeting with a advisor 72, or various highly interactive forms of communication. There may also be communications that consume intermediate levels of resources, such as class or group-based presentations/discussions with limited feedback or questions from participants.

In one implementation, a modularization analytics component (MAC) 160 may be provided. The MAC 160 may allow communication resources to be effectively and efficiently allocated among users 50 having differing needs and value to the business, and it may achieve this by, for example, grouping users together in terms of communications channels and mechanisms for communicating that vary in terms of the communication resources warranted. When an event occurs, such as a significant drop in a stock market index, information about the event may be provided from the external data sources 90 to the trigger engine 130. The trigger engine 130 may consider goals 126 of all users 50 that relate to stock holdings that may be impacted. However, not all users 50 warrant the same amount of communication resources regarding the event.

The MAC 160 may format an initial communication for the communication entity 70 to send to all affected users 50 that contains a brief description of what happened (market crash), with possibly some explanation as to why and basic recommendations that are applicable to the population at large. The scheduling component 170 may be utilized to check relevant advisor calendars or schedules of the advisor(s) 72 and relevant user calendars or schedules of the user(s) 50 for available times. The scheduling component may then receive calendar feedback from the user(s) or advisor(s) in order to schedule a contact time for the follow-on communication, which may be in the form of, e.g., a presentation by the advisor 72. An invitation to the follow-on communication may be included in the initial communication sent to the users 50.

A follow-on communication may have a first communication type or presentation type that is either a pre-recorded communication (lower resource, and may be presented multiple times for a given recording) or a real-time communication (higher resource). It may also have a second communication type in which the follow-on communications is a one-way communication from an advisor to a user, e.g., a presentation by the advisor but without allowing for any questions. This is a lower resource communication. The second communication type may be the same as the one-way communication, but also permit limited communications back from the user to the advisor. The limited communications may be limited in terms of acceptable channels of communication (e.g., only chat questions for an on-line presentation), amount of time for questions (e.g., a 10-min Q/A period), who can ask questions (e.g., only “gold-star” users have the ability to ask questions), or may be limited in some other way. A further second communication type may be a presentation that permits completely unlimited two-way communication, allowing a user to fully get all questions answered. The latter is the most resource-demanding mode of communicating.

The invitation to the users may include the type of follow-on communication to be utilized that varies between users and according to a user value or other characteristic of the user. For example, a user at one end of the spectrum may simply be sent, in the invitation, a link to a pre-recorded presentation on the topic of the stock market crash without the ability to interact at all with the presenter. A user on the other end of the spectrum may be sent an invitation to participate in a real-time on-line presentation on the topic with an unlimited ability to interact with the presenter during the presentation and/or to contact the presenter afterwards.

Two different follow-on communication types may contain overlapping components. For example, a first user may receive an invitation to an initial portion of a presentation which allows no user feedback. A second user may receive an invitation to the same presentation, but may also receive, in the invitation, a link to a follow-on question and answer period, or a second part of the invitation to directly contact the advisor about the specifics of the user's accounts.

Operation of the MAC 160 and the scheduling component 170 may be illustrated by the following use case in which the stock market has dropped three hundred points in response to news from overseas. An advisor 72 has one hundred users 50 who may be grouped by the MAC 160 into five different classes, Classes A through E based on various criteria such as value of accounts, historical frequency of communications, historical degree of activity, length of user time with the business, user sophistication, indicated or deduced preferences, and any other criteria.

Of the advisor's one hundred users 50, the MAC 160 determines that sixty of them are Class E users, which is the least communication resource demanding. An email may be sent to the Class E users containing a general portion that is automatically included when a large market drop occurs with reassuring information about stock market volatility and how stocks remains a good long-term investment despite short-term volatility. This email may also include a brief portion with details specific to this particular market drop that may be written by the advisor 72 or that may include articles or links with relevant information (the MAC 160 may send a message to the advisor 72 requesting additional information to be provided before sending out this email). The idea with this class of users is that they may simply receive some form of reassuring push notification that lets them know they are being thought of and that the business is looking out for them.

The MAC 160 may further determine that twenty of the users 50 are Class D users. In addition to receiving the email sent to the Class E users, the Class D users receive in invitation to a 30-minute on-line webinar or in-person presentation provided by the advisor 72 on strategies for dealing with such a market drop. This utilizes additional communication resources in that the advisor 72 must prepare the presentation and coordinate the logistics associated with its presentation.

The MAC 160 may further determine that ten of the users 50 are Class C users. In addition to the email and invitation of the Class D and Class E users, the Class C users are also invited to a further 30-minute question and answer session. This utilizes additional communication resources in terms of time and effort of the advisor 72 and may require the advisor 72 to do additional work if any of the questions require additional research. The MAC 160 may further determine that seven of the users 50 are Class B users that, in addition to the above, receive an invitation to a fifteen-minute call with the advisor 72 to personally discuss the stock market drop and its specific impact on the user's 50 portfolio. Finally, the MAC 160 may further determine that three of the users 50 are Class A users the proactively receive a call from the advisor 72 with possible follow-ups. Class A is the most demanding on communication resources of the advisor 72 and the criteria for allocating a user to such a class may be strict.

In the above use case, the classes may utilize modular communication components that are cumulative, meaning each more restrictive class utilizes the communications pieces from the less restrictive classes. However, this need not be the case, and two entirely different schemes may be utilized for different classes. For example, the Class A users may simply receive a telephone call from the advisor 72 without receiving the emails or invitation to the group presentation. The MAC 160 may assist with scheduling reminders, notices, etc. to facilitate the communications.

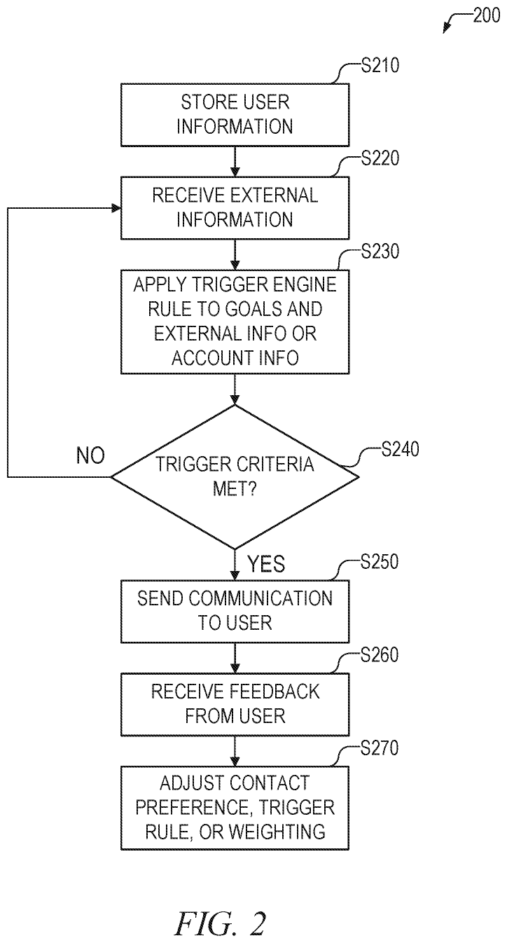

FIG. 2 is a flowchart illustrating an example process 200 of the system 100 in operation, according to an implementation. In operation S210, user information may be collected from the user in, e.g., an initial user questionnaire, user bootcamp activity or via some other mechanism, and stored in the user database 120. Each user record 122 may comprise, as described above, contact preferences 124, goals 126, and account information 128.

In operation S220, external information may be received via, e.g., a network interface from an external data source 90, such as a news feed, third-party database, and the like. This external information may relate to one or more of the users' goals 126. In operation S230, the trigger engine 130 may process the external information using word parsing phrase recognition, or other AI techniques in applying one or more trigger engine rules to determine, in operation S240, whether a trigger 134 criteria is met. If not (S240:No), the process simply returns to operation S220 of receiving additional external information. If the trigger 134 criteria is met (S240:Yes), then the trigger engine 130 may format a message or a communication, e.g., based in part on the user information, such as the contact preferences 124. In this operation, a channel (e.g., email, telephone, video, chat, etc.) of communication may be determined, as well as a format (brief summary, bullet point highlights, detailed discussion, hyperlinks) and other characteristics of the communication. This may be sent to the communication entity 70, which may be the advisor 72 or the robot/automated communications 102 routine, and, in operation S250, the communication entity 70 may send the communications to the user.

In operation S260, feedback (or lack of feedback) may be received from the user 50 related to the communication, and this feedback (/lack) may be determined and categorized as positive or negative. Negative feedback may be determined if there is no detectable response to the communication or no indication that the content of the communication was seen. Negative feedback may also be determined if the user 50 expressly communicates displeasure with the communication itself or the contents of the communication. Positive feedback, on the other hand, may be determined by the user 50 expressly communicating pleasure with the communication or its contents, or may be inferred based on follow-up inquiries by the user, following of links within the communication, or other indications of interaction with the subject matter of the communications.

In operation S270, if the feedback is determined to be negative, the user's 50 contact preference 124, trigger rule 134, or weighting of the rule may be adjusted to reduce similar communications to the user in the future. Conversely, if the feedback is determined to be positive, the user's 50 contact preference 124, trigger rule 134, or weighting of the rule may be adjusted to increase similar communications to the user in the future. Statistical tests or various forms of AI may be utilized to determine whether the feedback is related to the communication channel used, the format, or the content/subject matter. For example, if the user 50 feedback is generally negative with bullet-point texts, but favorable with detailed emails, then the channel and message format may be adjusted. Conversely, if a particular topic, such as green-focused mutual funds, generally receives negative feedback regardless of the channel and message format, then aspects related to the content may be adjusted. The adjustment in operation S270 may also include adjustments to contact preferences 124, trigger rules 134, or weighting of the rules of groups of users having similar attributes or to all of the users globally.

### General Computer and Network Architecture

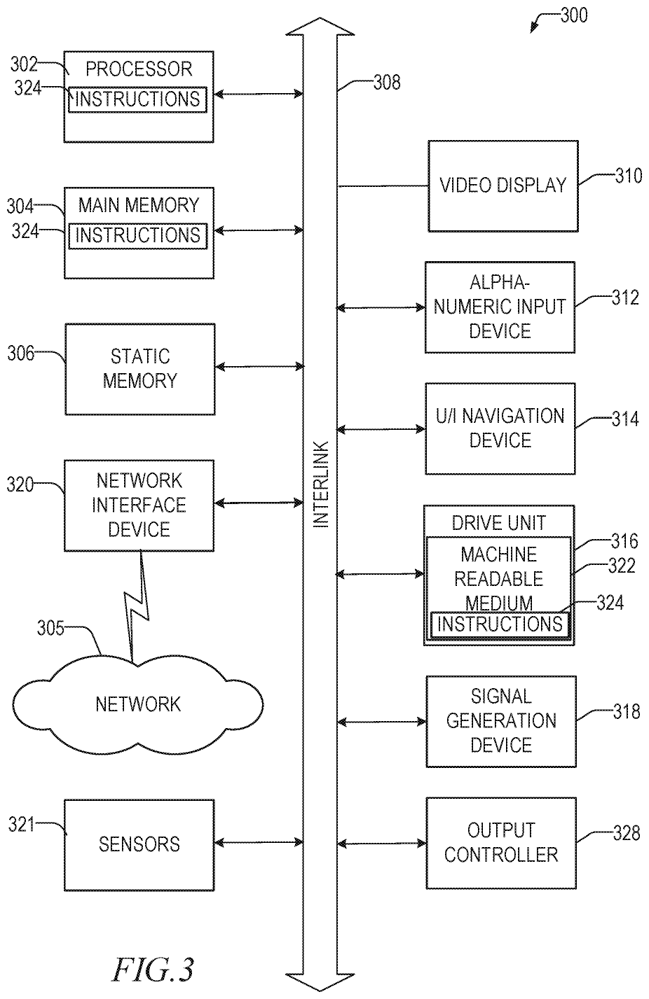

To describe some configurations in greater detail, reference is made to examples of hardware structures and interconnections usable in the designs of the present disclosure. FIG. 3 is a block diagram illustrating a machine 300 that may be a computer or computer system on which various processes described herein may be performed. The machine 300 or multiple such machines may form various parts or all of the system 100 described above. Such a machine 300 may include a hardware processor 302 (e.g., a central processing unit (CPU), a graphics processing unit (GPU), a hardware processor core, or any combination thereof), a main memory 304 and a static memory 306, some or all of which may communicate with each other via an interlink (e.g., bus) 308. The machine 300 may further include a display unit 310, an alphanumeric input device 312 (e.g., a keyboard), and a user interface (UI) navigation device 314 (e.g., a mouse). In an example described herein, the display unit 310, input device 312 and UI navigation device 314 may be a touch screen display. The machine 300 may additionally include a storage device (e.g., drive unit) 316, a signal generation device 318 (e.g., a speaker), a network interface device 320, and one or more sensors 321, such as a global positioning system (GPS) sensor, compass, accelerometer, or other sensor. The machine 300 may include an output controller 328, such as a serial (e.g., universal serial bus (USB)), parallel, or other wired or wireless (e.g., infrared (IR), near field communication (NFC), etc.) controller connection to communicate or control one or more peripheral devices (e.g., a printer, card reader, etc.).

The storage device 316 may include a machine readable medium 322 on which is stored one or more sets of data structures or instructions 324 (e.g., software) embodying or utilized by any one or more of the techniques or functions described herein. The instructions 324 may also reside, completely or at least partially, within the main memory 304, within static memory 306, or within the hardware processor 302 during execution thereof by the machine 300. In an example, one or any combination of the hardware processor 302, the main memory 304, the static memory 306, or the storage device 316 may constitute machine readable media.

While the machine readable medium 322 is illustrated as a single medium, the term “machine readable medium” may include a single medium or multiple media (e.g., a centralized or distributed database, and/or associated caches and servers) configured to store the one or more instructions 324.

The term “machine readable medium” may include any medium that is capable of storing encoding or carrying instructions for execution by the machine 300 and that cause the machine 300 to perform any one or more of the techniques of the present disclosure, or that is capable of storing encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 324 may further be transmitted or received over the communications network 305 using a transmission medium via the network interface device 320. The term “transmission medium” is defined herein to include any medium that is capable of storing encoding or carrying instructions for execution by the machine, and includes distal or analog communications signals or other medium to facilitate communication of such software.

The machine 300 may communicate with one or more other machines 300 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 302.11 family of standards known as Wi-Fi®, IEEE 302.16 family of standards known as WiMax®), IEEE 302.15.4 family of standards, a Long Term Evolution (LTE) family of standards, a Universal Mobile Telecommunications System (UMTS) family of standards, peer-to-peer (P2P) networks, virtual private networks (VPN), or any other way of transferring data between machines 300. In an example, the network interface device 320 may include one or more physical jacks (e.g., Ethernet, coaxial, or phone jacks) or one or more antennas to connect to the communications network 305.

In an example, the network interface device 320 may include a plurality of antennas to wirelessly communicate using at least one of single-input multiple-output (SIMO), multiple-input multiple-output (MIMO), or multiple-input single-output (MISO) techniques. In some examples, the network interface device 320 may wirelessly communicate using Multiple User MIMO techniques.

A wide variety of computing devices may constitute a machine 300, as described herein. The following list includes a variety of devices that may fit the definition of a machine 300: a personal data assistant (PDA), a cellular telephone, including a smartphone, a tablet computing device, a laptop computer, a desktop computer, a workstation, a server computer, a mainframe computer, and the like.

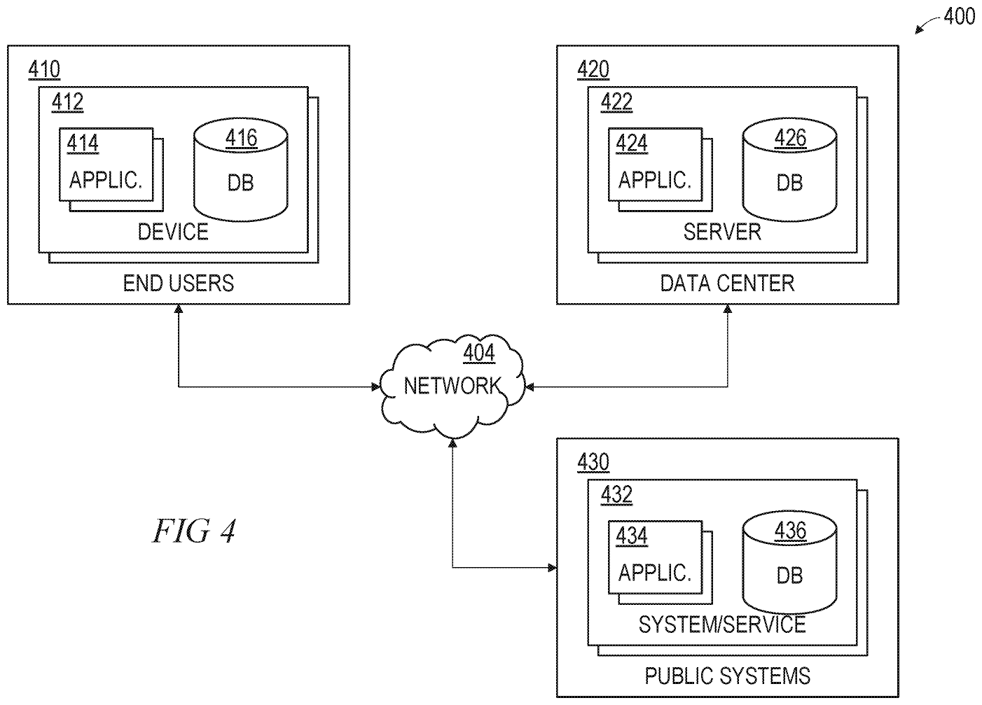

FIG. 4 is a block diagram of a distributed system 400 that may include a user-server architecture or cloud computing system. The system 400 may be a system 100 as described above. Distributed system 400 may have one or more end users 410. An end user 410 may have various computing devices 412, which may be machines 300 as described above. The end-user computing devices 412 may comprise applications 414 that are either designed to execute in a stand-alone manner, or interact with other applications 414 located on the device 412 or accessible via the network 305, 404. These devices 412 may also comprise a data store 416 that holds data locally, the data being potentially accessible by the local applications 414 or by remote applications.

The system 400 may also include one or more data centers 420. A data center 420 may be a server 422 or the like associated with a business entity that an end user 410 may interact with. The business entity may be a computer service provider, as may be the case for a cloud services provider, or it may be a consumer product or service provider, such as a retailer. The data center 420 may comprise one or more applications 424 and databases 426 that are designed to interface with the applications 414 and databases 416 of end-user devices 412. Data centers 420 may represent facilities in different geographic locations where the servers 422 may be located. Each of the servers 422 may be in the form of a machine(s) 300.

The system 400 may also include publicly available systems 430 that comprise various systems or services 432, including applications 434 and their respective databases 436. Such applications 434 may include news and other information feeds, search engines, social media applications, and the like. The systems or services 432 may be provided as comprising a machine(s) 300.

The end-user devices 412, data center servers 422, and public systems or services 432 may be configured to connect with each other via the network 305, and access to the network by machines may be made via a common connection point or different connection points, e.g. a wireless connection point and a wired connection. Any combination of common or different connections points may be present, and any combination of wired and wireless connection points may be present as well. The network 305, end users 410, data centers 420, and public systems 430 may include network hardware such as routers, switches, load balancers and/or other network devices.

Other implementations of the system 400 are also possible. For example, devices other than the user devices 412 and servers 422 shown may be included in the system 400. In an implementation, one or more additional servers may operate as a cloud infrastructure control, from which servers and/or users of the cloud infrastructure are monitored, controlled and/or configured. For example, some or all of the techniques described herein may operate on these cloud infrastructure control servers. Alternatively, or in addition, some or all of the techniques described herein may operate on the servers 422.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products.

Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like. The code may also be intangibly stored on one or more non-transitory and non-volatile computer readable media, such as those described above. In these cases, instructions resident on the media are read and executed by a processor to perform various functions.

The above description is intended to be illustrative, and not restrictive. For example, the above-described examples (or one or more aspects/configurations thereof) may be used in combination with others. Other embodiments may be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it should not be used to interpret or limit the scope or meaning of the claims.

Also, in the above Detailed Description, various features may be grouped together to streamline the disclosure. However, the claims cannot set forth every feature disclosed herein, as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the claims, along with the full scope of equivalents to which such claims are entitled.

1. A computer-implemented method for adaptively controlling communication activity of a communication system, the method comprising, using a processor of the communication system:
storing user information for a user in a user-specific database of the communication system, the user information comprising contact preferences, a goal comprising information related to a future objective of the user, and account information;
receiving, over a network interface of the communication system, external information from an external data source by a trigger engine;
applying, by the trigger engine, a trigger rule to determine a degree of relatedness between the goal and at least one of the external information or the account information, based on a trigger rule criterion;
applying a modularization analytics component to allocate communication resources among a plurality of users by grouping the plurality of users based on value of accounts, historical frequency of communications, historical degree of activity, length of user time with a business, user sophistication, and indicated or deduced preferences, wherein the modularization analytics component determines an optimal frequency for communications while preserving computational resources;
using the modularization analytics component and the trigger rule to dynamically adjust the optimal frequency of communications to preserve computational resources of the communication system;
when the degree of relatedness exceeds a threshold value, utilizing the contact preferences from the user-specific database and the modularization analytics component to provide a format of a communication related to the external information for a communication entity based on the allocated communication resources and the contact preferences;
using an artificial intelligence component to adjust a type, content, or group of recipients of the communication;
using an automatic communications component including the artificial intelligence component to send the communication to the user and the group of recipients by the communication entity according to the contact preferences;
displaying a user-selectable portion on a display of a device of the user, the user-selectable portion including a positive indicator and a negative indicator;
based on a feedback status from the user related to the communication derived from receipt of a user input from the user-selectable portion, and using the artificial intelligence component of the automatic communications component, determining whether the feedback status is related to the format or the content of the communication and correspondingly adjusting the trigger rule, the contact preferences, and the format of the communication; and
storing at least the adjusted contact preferences in the user-specific database.

2. The method of claim 1, wherein:
the contact preferences comprise a channel, a contact time, and a contact frequency for communicating with the user;
lack of feedback or negative feedback reduces the contact frequency; and
positive feedback increases the contact frequency.

3. The method of claim 2, wherein the channel is one of an email, a phone call, a video communication, a text-based chat, or a virtual reality communication.

4. The method of claim 1, further comprising:
accessing, by a scheduling component, at least one of a user calendar or an advisor calendar to determine one or more available times for follow-on communication between the user and an advisor;
formatting a message of the one or more available times as the communication;
receiving calendar feedback from the user based on the communication; and
scheduling a contact time for the follow-on communication based on the calendar feedback.

5. The method of claim 1, further comprising:
receiving at least part of the user information from the user based on an initial user questionnaire.

6. The method of claim 1, wherein the goal comprises information related to at least one of age, family, current income, holdings, risks, insurance, or tuition of the user.

7. The method of claim 1, wherein the trigger rule is based on at least one of a time-based event, a financial event, a family event, a health event, or an external event.

8. The method of claim 1, wherein the communication contains only words or phrases that are in a positive form, the positive form using a positive tone or words with a positive connotation.

9. The method of claim 1, wherein the trigger rule is a predictive trigger rule based on at least one of a detected income or source change, a change in cash flow, a portfolio drifting, spending, an out-of-pattern cash flow, or a detected user attribute.

10. The method of claim 1, wherein the trigger rule is based on based on past user actions comprising at least one of prior user reaction to an event or a user indication of desired activities.

11. The method of claim 1, wherein the contact preferences include at least one of a communication channel, time, content, frequency, or volume.

12. The method of claim 11, wherein the contact preferences are at least partially based on demographic defaults for the user.

13. The method of claim 1, wherein the trigger rule is a multi-user trigger rule that applies globally to a plurality of users or that applies to user groups in which users in a group share a common attribute.

14. The method of claim 13, further comprising adjusting the multi-user trigger rule or a weighting factor associated with the multi-user trigger rule based on feedback or lack of feedback received from a plurality of users.

15. The method of claim 1, further comprising an additional trigger rule used to determine the degree of relatedness between the goal and at least one of the external information and the account information, wherein the additional trigger rule has a weighting factor.

16. The method of claim 1, further comprising:
storing second user information for a second user, the second user information comprising second contact preferences and a second goal, the second goal comprising information related to a future objective of the second user;
applying, by the trigger engine, a second trigger rule to determine a second degree of relatedness between the external information and the second goal, based on a second trigger rule criterion;
when the second degree of relatedness exceeds a second threshold value, then utilizing the second contact preferences to format a second communication related to the external information for the communication entity based on the second contact preferences; and
sending the second communication to the second user by the communication entity according to the second contact preferences;
wherein:
the communication is an invitation to a first follow-on communication for the user;
the second communication is a second invitation for a second follow-on communication for the second user; and
the first follow-on communication and the second follow-on communication at least partially differ from one another.

17. The method of claim 16, wherein the first follow-on communication and the second follow-on communication have a portion that is common to each other.

18. The method of claim 16, wherein the first follow-on communication and the second follow-on communication are presentations comprising:
a first presentation type that is one of a pre-recorded communication and a real-time communication; and
a second presentation type that is one of a one-way communication from an advisor to at least one of the user and the second user, a limited two-way communication, and an unlimited two-way communication.

19. A user communication system comprising:
a hardware processor; and
a non-volatile memory-based storage device connected to the hardware processor comprising instructions that, when executed on the hardware processor, configure the hardware processor to:
store user information for a user in a user-specific database of the communication system, the user information comprising contact preferences, a goal comprising information related to a future objective of the user, and account information;
receive external information from an external data source by a trigger engine;
apply, using the trigger engine, a trigger rule to determine a degree of relatedness between the goal and at least one of the external information or the account information, based on a trigger rule criterion;
apply a modularization analytics component to allocate communication resources among a plurality of users by grouping the plurality of users based on value of accounts, historical frequency of communications, historical degree of activity, length of user time with a business, user sophistication, and indicated or deduced preferences, wherein the modularization analytics component determines an optimal frequency for communications while preserving computational resources;
use the modularization analytics component and the trigger rule to dynamically adjust the optimal frequency of communications to preserve computational resources of the communication system;
when the degree of relatedness exceeds a threshold value, then utilize the contact preferences from the user-specific database and the modularization analytics component to provide a format of a communication related to the external information for a communication entity based on the allocated communication resources and the contact preferences;
use an artificial intelligence component to adjust a type, content, or group of recipients of the communication;
use an automatic communications component including the artificial intelligence component to send the communication to the user and the group of recipients by the communication entity according to the contact preferences;
display a user-selectable portion on a display of a device of the user, the user-selectable portion including a positive indicator and a negative indicator;
based on a feedback status from the user related to the communication derived from receipt of a user input from the user-selectable portion, and using the artificial intelligence component of the automatic communications component, determine whether the feedback status is related to the format or the content of the communication and correspondingly adjust the trigger rule, the contact preferences, and the format of the communication; and
store at least the adjusted contact preferences in the user-specific database.

20. The user communication system of claim 19, further comprising a scheduling component that utilizes the hardware processor to:
access at least one of a user calendar or an advisor calendar to determine one or more available times for follow-on communications between the user and an advisor;
format a message of the one or more available times as the communication;
receive calendar feedback from the user based on the communication; and
schedule a contact time for the follow-on communication based on the calendar feedback.

21. The user communication system of claim 19, wherein the instructions further configure the hardware processor to:
store second user information for a second user, the second user information comprising second contact preferences and a second goal, the second goal comprising information related to a future objective of the second user;
apply a second trigger rule to determine a second degree of relatedness between the external information and the second goal, based on a second trigger rule criterion;
when the second degree of relatedness exceeds a second threshold value, then utilize the second contact preferences to format a second communication related to the external information for the communication entity based on the second contact preferences; and
send the second communication to the second user by the communication entity according to the second contact preferences;
wherein:
the communication is an invitation to a follow-on communication for the user;
the second communication is a second invitation for a second follow-on communication for the second user; and
the follow-on communication and the second follow-on communication at least partially differ from one another.

22. A non-transitory computer-readable storage medium, the computer-readable storage medium including instructions that when executed by a processor, cause the processor to:
store user information for a user in a user-specific database of a communication system, the user information comprising contact preferences, a goal comprising information related to a future objective of the user, and account information;
receive external information from an external data source by a trigger engine;
apply, using the trigger engine, a trigger rule to determine a degree of relatedness between the goal and at least one of the external information or the account information, based on a trigger rule criterion;
apply a modularization analytics component to allocate communication resources among a plurality of users by grouping the plurality of users based on value of accounts, historical frequency of communications, historical degree of activity, length of user time with a business, user sophistication, and indicated or deduced preferences, wherein the modularization analytics component determines an optimal frequency for communications while preserving computational resources;
use the modularization analytics component and the trigger rule to dynamically adjust the optimal frequency of communications to preserve computational resources of the communication system;
when the degree of relatedness exceeds a threshold value, then utilize the contact preferences from the user-specific database and the modularization analytics component to provide a format of a communication related to the external information for a communication entity based on the allocated communication resources and the contact preferences;
use an artificial intelligence component to adjust a type, content, or group of recipients of the communication;
use an automatic communications component including the artificial intelligence component to send the communication to the user and the group of recipients by the communication entity according to the contact preferences;
display a user-selectable portion on a display of a device of the user, the user-selectable portion including a positive indicator and a negative indicator;
based on a feedback status from the user related to the communication derived from receipt of a user input from the user-selectable portion, and using the artificial intelligence component of the automatic communications component, determine whether the feedback status is related to the format or the content of the communication and correspondingly adjust the trigger rule, the contact preferences, and the format of the communication; and
store at least the adjusted contact preferences in the user-specific database.

23. The non-transitory computer-readable storage medium of claim 22, wherein the instructions further cause the processor to:
access at least one of a user calendar or an advisor calendar to determine one or more available times for follow-on communications between the user and an advisor;
format a message of the one or more available times as the communication;
receive calendar feedback from the user based on the communication; and
schedule a contact time for the follow-on communication based on the calendar feedback.
